(19) United States
(12) Patent Application Publication
(10) Pub. No.: US 2026/0086384 A1
(43) Pub. Date: Mar. 26, 2026

(54) LOW-PROFILE POLARIZATION-SPLITTING CAMERAS

(71) Applicant: Apple Inc., Cupertino, CA (US)

(72) Inventors: Milan Maksimovic, Sunnyvale, CA (US); Muhammad A Zaidi, San Diego, CA (US); David Lara, London (GB); Miodrag Scepanovic, San Jose, CA (US); Regis Tessieres, La Tronche (FR)

(21) Appl. No.: 19/312,285

(22) Filed: Aug. 27, 2025

Related U.S. Application Data
(60) Provisional application No. 63/699,773, filed on Sep. 26, 2024.

(51) Int. Cl. G02B 27/28; H04N 23/55

(52) U.S. Cl. CPC G02B 27/283; G02B 27/286; H04N 23/55

(57) ABSTRACT

Embodiments are directed to polarization-splitting cameras that are capable of generating multiple polarization images as part of a single image capture operation, where each polarization image corresponds to a different polarization state of light received by the polarization-splitting camera. Specifically, the polarization-splitting cameras described herein may include a metasurface assembly that includes a first metasurface layer and a second metasurface layer. The first metasurface layer is configured to image light from different portions a field of view of the polarization-splitting camera to different regions of the second metasurface layer, and the second metasurface is configured to split this light based on its polarization state.

### CROSS-REFERENCE TO RELATED APPLICATIONS

This application claims the benefit under 35 U.S.C. § 119 (e) of U.S. Provisional Patent Application No. 63/699,773, filed Sep. 26, 2024, the disclosure of which is hereby incorporated herein by reference in its entirety.

### FIELD

This disclosure relates to polarization-splitting cameras that capture images of multiple polarization states of incoming light. More specifically, this disclosure relates to polarization-splitting cameras that include multiple metasurface layers.

### BACKGROUND

The ability to measure the polarization of light is beneficial in many imaging applications. For example, the polarization of light received from a scene may help distinguish between different materials, and accordingly may be useful across a range of contexts, such as in authentication or medical applications. For example, when an electronic device utilizes facial recognition for user authentication, polarization information may be used to confirm the presence of a living person (as opposed to a mask or bust presented in an attempt to pass as an authorized user). Accordingly, polarization imaging may be a desirable feature for a range of devices, including consumer electronic devices such as smartphones, tables, and computers. Space is at a premium in these devices, and imaging systems that measure polarization tend to be large and/or include complicated mechanisms like moving polarizers. Accordingly, it may be desirable to provide an imaging assembly with polarization measurement capabilities that fits within the physical constraints imposed by consumer electronic devices.

### SUMMARY

Embodiments described herein are directed to systems, devices, and methods for capturing polarization images. Some embodiments are directed to a polarization-splitting camera that includes an image sensor comprising an array of sensor pixels divided into an array of sensing regions, a first metasurface layer that includes an array of routing regions, and a second metasurface layer positioned between the first metasurface layer and the image sensor, where the second metasurface layer includes an array splitting regions. Each routing region of the plurality of routing regions has a different corresponding field of coverage. Each routing region of the array of routing regions is configured to direct light received from the corresponding field of coverage to a corresponding splitting region of the plurality of splitting regions. The corresponding splitting region is configured to split the received light into a corresponding plurality of light beams, where each output beam of the corresponding plurality of light beams has a different polarization state. Additionally, the corresponding splitting region is configured to direct the corresponding plurality of light beams to a corresponding sensing region of the plurality of sensing regions.

In some variations, each sensing region of the plurality of sensing regions includes a corresponding plurality of subregions. In these variations, the corresponding splitting region (e.g., corresponding to a particular routing region) is configured to direct each output beam of the corresponding plurality of light beams to a different subregion of the corresponding plurality of subregions of the corresponding sensing region. In some of these variations, each subregion of each sensing region of the plurality of sensing regions comprises a plurality of sensor pixels.

In some variations, the fields of coverage of the plurality of routing regions have a common size and/or shape. Additionally or alternatively, the polarization-splitting camera may include a cover layer. Additionally or alternatively, the polarization-splitting camera may include a set of substrates connecting the first metasurface layer to the second metasurface layer.

Other embodiments are directed to an electronic device that includes a polarization-splitting camera configured to capture an image of a field of view of a scene. The polarization-splitting camera includes a cover layer and a metasurface assembly positioned directly behind the cover layer, where the metasurface assembly comprising a first metasurface layer and a second metasurface layer. The polarization-splitting camera includes an image sensor positioned behind the metasurface assembly, where the metasurface assembly is divided into an array of assembly regions. In these variations, each assembly region of the metasurface assembly is configured to: i) collect light from a substantially different corresponding portion of the field of view; ii) split the collected light into a plurality of light beams having different polarization states; and iii) direct each of the plurality of light beams to a different corresponding portion of the image sensor. In some variations, immediately adjacent assembly regions are configured to collect light from immediately adjacent portions of the field of view.

In some variations, the cover layer defines an exterior surface of the electronic device. Additionally or alternatively, each assembly region of the metasurface assembly may include a corresponding region of the first metasurface layer and a corresponding region of the second metasurface layer, where the corresponding region of the first metasurface layer is configured to route light received from the corresponding portion of the field of view to the corresponding region of the second metasurface layer.

In some variations, the polarization-splitting camera includes a set of substrates connecting the first metasurface layer to the second metasurface layer. In some of these variations, the set of substrates includes a plurality of substrates. In some instances, the metasurface assembly may be separated from the cover layer by a gap. Additionally or alternatively, the metasurface assembly may separated from the image sensor by a gap. The electronic device may include one or more processors configured to generate a plurality of polarization images from the captured image.

Still other embodiments are directed to a polarization-splitting camera that includes a cover layer, an image sensor, and a metasurface assembly. The metasurface assembly includes a first metasurface layer that defines an array of routing regions having substantially non-overlapping fields of coverage, a second metasurface layer, and a set of substrates connecting the first metasurface layer to the second metasurface layer. Each routing region of the array of routing regions may be configured to direct light received through the cover layer to a corresponding region of the second metasurface layer, and the corresponding region of the second metasurface layer may configured to split the received light into a corresponding plurality of light beams. Each output beam of the corresponding plurality of light beams has a different polarization state.

For example, the corresponding plurality of light beams may include a first light beam having a first polarization state, a second light beam having a second polarization state, a third light beam having a third polarization state, and a fourth light beam having a fourth polarization state. In some of these variations, the first light beam is polarized at a 0 degree polarization angle, the second light beam is polarized at a 45 degree polarization angle, the third light beam is polarized at a 90 degree polarization angle, and the fourth light beam is polarized at a 135 degree polarization angle. In some variations, the set of substrates comprises a plurality of substrates. Additionally or alternatively, the metasurface assembly is separated from the image sensor by a gap.

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A and 1B show front and rear views, respectively, of an example of an electronic device having a polarization-splitting camera. FIG. 1C depicts exemplary components of the device of FIGS. 1A and 1B.

FIG. 2 depicts a schematic view of an example of a polarization-splitting camera.

FIGS. 3A and 3B show partial cross-sectional side views of variations of polarization-splitting cameras as described herein.

FIG. 4A shows a scene in which the polarization-splitting camera of FIG. 3A is positioned to capture an image of the scene. FIG. 4B shows a top view of a metasurface layer of the polarization-splitting camera of FIG. 3A. FIG. 4C shows a top view of an image sensor of the polarization-splitting camera of FIG. 3A. FIG. 4D shows a top view of a pixel group of the image sensor of FIG. 4C.

FIG. 5 shows a scene that includes a partial cross-sectional side view of a variation of a polarization-splitting camera as described herein, where the polarization-splitting camera is positioned to capture an image of the scene.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to polarization-splitting cameras that are capable of generating multiple polarization images as part of a single image capture operation, where each polarization image corresponds to a different polarization state of light received by the polarization-splitting camera. Specifically, the polarization-splitting cameras described herein may include a metasurface assembly that includes at least a first metasurface layer and a second metasurface layer. The first metasurface layer is configured to image light from different portions a field of view of the polarization-splitting camera to different regions of the second metasurface layer, and the second metasurface is configured to split this light based on its polarization state. It should also be appreciated the principles described herein may be similarly applied to cameras in which the second metasurface is configured to split light based on its spectral content, which may allow for the generation of multiple spectral images from a single image capture operation.

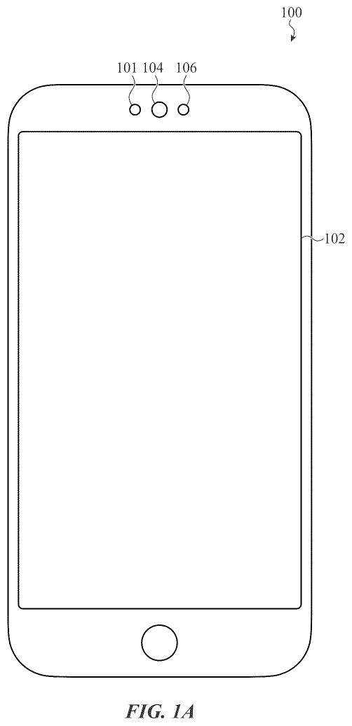

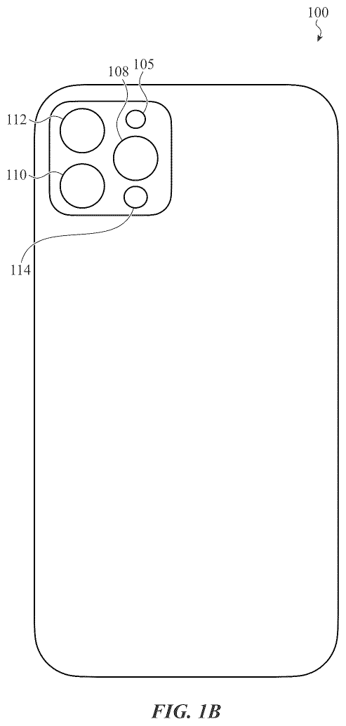

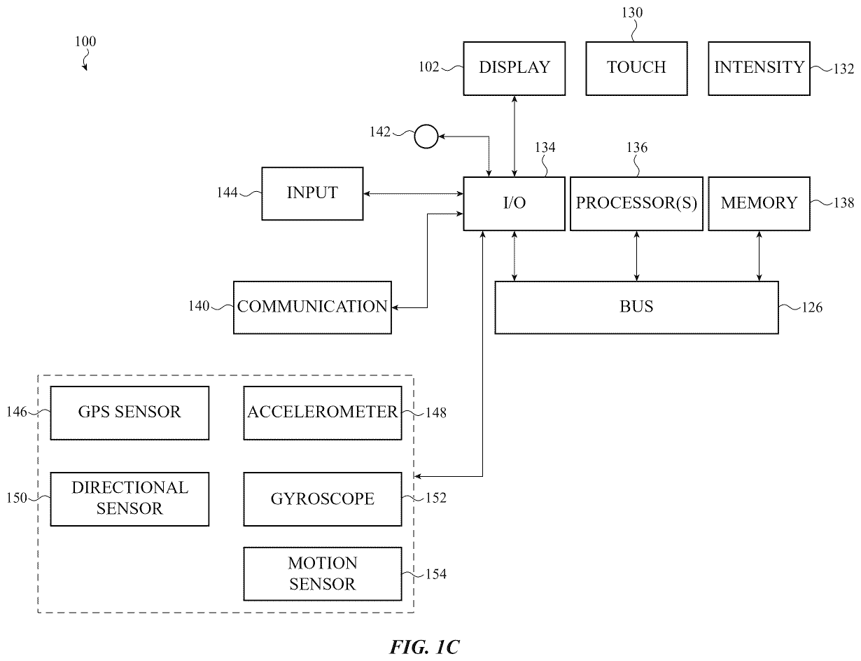

These and other embodiments are discussed below with reference to FIGS. 1A-5. However, those skilled in the art will readily appreciate that the detailed description given herein with respect to these Figures is for explanatory purposes only and should not be construed as limiting.

The polarization-splitting cameras described herein may be incorporated into an electronic device such as a phone, tablet, wearable device such as a head-mounted device or a smartwatch, computer, or the like, and may thereby provide polarization imaging capabilities to the electronic device. FIGS. 1A-1C depict an example electronic device 100 as described herein that includes a polarization-splitting camera 104. FIG. 1A shows a front view of the electronic device 100, which includes a display 102, a front-facing flash module 101, and a polarization-splitting camera 104. The display 102 may provide a graphical output that is viewable through or at a front exterior surface of the electronic device 100. The polarization-splitting camera 104 is positioned to view a portion of the environment in front of the display 102 (i.e., the “field of view”, which is the spatial extent of a scene that a camera is able to capture using an image sensor of the camera). Similarly, the front-facing flash module 101 may illuminate a portion of the environment in front of the display 102 (i.e., the “field of illumination” of the front-facing flash module 101). The field of illumination of the front-facing flash module 101 at least partially overlaps the field of view of the polarization-splitting camera 104, which allows the front-facing flash module 101 to illuminate the camera's field of view during image capture. In instances where the polarization-splitting camera is configured to capture polarization images at a particular range of operating wavelengths, the front-facing flash module 101 may be configured to emit light at a wavelength within this range. Additionally, in some instances the front-facing flash module 101 may be configured to emit light that is polarized with one or more specific polarization states.

In some instances, the electronic device 100 may further include a front-facing depth sensor 106 that may calculate depth information for a portion of the environment in front of the electronic device 100. Specifically, the front-facing depth sensor 106 may calculate depth information within a field of coverage (i.e., the widest lateral extent to which the depth sensor is capable of providing depth information). The field of coverage of the front-facing depth sensor 106 may at least partially overlap the field of view of the polarization-splitting camera 104, thereby allowing the front-facing depth sensor 106 to calculate depth information associated with the field of view of the polarization-splitting camera 104. The front-facing depth sensor 106 may be any suitable system that is capable of calculating the distance between the front-facing depth sensor 106 and various points in the environment around the electronic device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In still other variations, depth information may be calculated from a polarization-splitting camera as described herein. Specifically, polarization information derived from objects in a scene may be used to determine the location and/or shape of these objects. In some of these variations, the polarization-splitting camera may be operated to capture images while a scene is illuminated with light that is polarized with one or more specific polarization states. In instances where a depth sensor (including a polarization-splitting camera used to determine depth information) utilizes infrared illumination, this infrared illumination may be utilized in a range of ambient conditions without being perceived by a user.

While the polarization-splitting camera 104 is shown in FIG. 1A as a front-facing camera, it should be appreciated that a polarization-splitting camera as described herein may be configured to capture polarization images in any direction relative to the electronic device 100. For example, FIG. 1B shows a rear view of the electronic device 100, which includes a set of rear-facing cameras and a rear-facing flash module 105. In the variation shown in FIG. 1B, the set of rear-facing cameras includes a first rear-facing camera 108, a second rear-facing camera 110, and a third rear-facing camera 112. The rear-facing cameras may have fields of view that at least partially overlap with each other, which may allow the rear-facing cameras to capture different aspects of a scene facing a rear surface of the electronic device 100. For example, in some instances each rear-facing camera has a different focal length, and thereby has a corresponding field of view with a different size. The choice of the size of a camera's field of view may impact the situations in which a particular camera may be useful. For example, cameras with longer focal lengths (and narrower fields of view) are often used in telephoto imaging where it is desirable to increase the magnification of a subject at farther distances, while cameras with shorter focal lengths (and wider fields of view) are often used in instances where it is desirable to capture more of a scene (e.g., landscape photography).

The field of illumination of the rear-facing flash module 105 at least partially overlaps the fields of view for some or all of the rear-facing cameras (e.g., any or all of the first rear-facing camera 108, the second rear-facing camera 110, and the third rear-facing camera 112). To the extent that the field of illumination of the rear-facing flash module 105 overlaps with a corresponding field of view of one of these cameras, the rear-facing flash module 105 may illuminate that camera's field of view during image capture. Also shown there is a rear-facing depth sensor 114, which may be configured in any manner as discussed previously with respect to the front-facing depth sensor 106. A field of coverage of the rear-facing depth sensor 114 may at least partially overlap the fields of view of some or all of the rear-facing cameras, thereby allowing the rear-facing depth sensor 114 to calculate depth information associated with the corresponding fields of view. Any or all of the rear-facing cameras may be configured as a polarization-splitting camera as described herein.

While the electronic device 100 is shown in FIGS. 1A and 1B as having four cameras, two flash modules, and two depth sensors, it should be appreciated that the electronic device 100 may have any number of cameras and flash modules as desired. Similarly, any camera or cameras of the electronic device 100 may be configured as a polarization-splitting camera as described herein. For the purpose of illustration, the principles of operation described herein are described with respect to a single polarization-splitting camera, which may represent any camera of that device (e.g., a front-facing camera, a rear-facing camera, or the like).

In some embodiments, the electronic device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. In other embodiments, the electronic device 100 is a wearable device. For example, in some instances the electronic device 100 may be a head-mounted device, such as an extended reality (XR) device, which may include augmented reality (AR) or virtual reality (VR) devices. Exemplary embodiments of head-mounted devices include, without limitation, the Vision Pro® device from Apple Inc. of Cupertino, California. Other portable electronic devices, such as laptops or tablet computers with touch-sensitive surfaces (e.g., touch screen displays and/or touchpads), smartwatches or the like are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., display 102). In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1C depicts exemplary components of electronic device 100. In some embodiments, electronic device 100 has a bus 126 that operatively couples I/O section 134 with one or more computer processors 136 and memory 138. I/O section 134 can be connected to display 102, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. Electronic device 100 can include input mechanisms 142 and/or 144. Input mechanism 142 is, optionally, a rotatable input device or a depressible and rotatable input device, for example. Input mechanism 142 is, optionally, a button, in some examples. Electronic device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the electronic device 100 or a portion thereof.

Memory 138 of electronic device 100 can include one or more non-transitory computer-readable storage devices, for storing computer-executable instructions, which, when executed by one or more computer processors 136, for example, can cause the computer processors to perform an image capture operation using the polarization-splitting cameras described herein to generate one or more polarization images. A computer-readable storage device can be any medium that can tangibly contain or store computer-executable instructions for use by or in connection with the instruction execution system, apparatus, or device. In some examples, the storage device is a transitory computer-readable storage medium. In some examples, the storage device is a non-transitory computer-readable storage medium. The non-transitory computer-readable storage device can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of electronic device 100, as well as to facilitate capturing of polarization images as described herein. Electronic device 100 is not limited to the components and configuration of FIG. 1C but can include other or additional components in multiple configurations.

Accordingly, any of the processes described herein may be stored as instructions on a non-transitory computer-readable storage device, such that a processor may utilize these instructions to perform the various steps of the processes described herein. Similarly, the devices described herein include a memory (e.g., memory 138) and one or more processors (e.g., processor 136) operatively coupled to the memory. The one or more processors may receive instructions from the memory and are configured to execute these instructions to facilitate capturing image and generating polarization images as described herein.

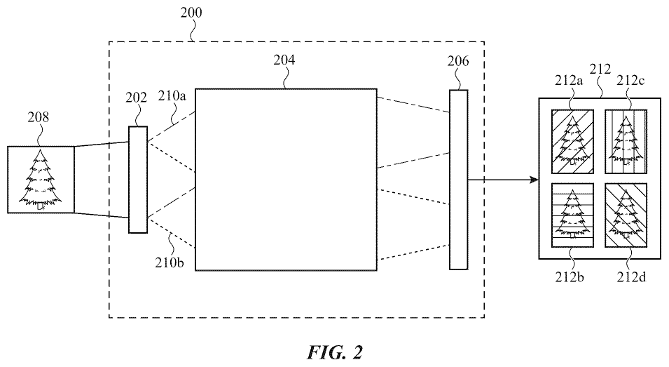

Polarization-splitting cameras typically require relatively large optics to capture and route light, especially when a larger field of view is desired. For example, FIG. 2 shows an example of a polarization-splitting camera 200. The polarization-splitting camera 200 includes a polarization-splitting component 202, a lens stack 204, and an image sensor 206. In the variation of the polarization-splitting camera 200 shown in FIG. 2, the polarization-splitting component 202 is positioned in between the lens stack 204 and a scene (depicted in FIG. 2 by region 208) that is imaged by the polarization-splitting camera 200. Specifically, the polarization-splitting component 202 (which may include a metasurface layer or another component capable of splitting light based on its polarization) to split incoming light based on its polarization. For example, the polarization-splitting component 202 may receive light captured from the region 208 into a plurality of different light beams 210a-210b, each having a different polarization. While two light beams (e.g., a first light beam 210a having a first polarization and a second light beam 210b having a different second polarization) are shown in FIG. 2, it should be appreciated that the polarization-spitting component may be configured to split incoming light into a different number of light beams (e.g., three light beams, four light beams, or five or more light beams).

The lens stack 204, which may include one or more lens elements, may receive the plurality of light beams 210a-210b generated by the polarization-splitting component 202, and may focus each of these light beams onto a different corresponding region of the image sensor 206. Accordingly, the image sensor 206, as part of an image capture operation, may capture a single image 212 that includes a plurality of polarization images 212a-212d. For example, a first portion of the image sensor 206 may capture light of the first polarization (e.g., from the first light beam 210a), and thus the image 212 may include a first polarization image 212a corresponding to the first portion of the image sensor 206. A second portion of the image sensor 206 may capture light of the second polarization (e.g., from the second light beam 210b), and thus the image 212 may include a second polarization image 212b corresponding to the second portion of the image sensor 206. Similarly, a third region and a fourth region of the image sensor 206 may capture light of a third polarization and a fourth polarization, respectively (e.g., from respective third and fourth light beams generated by the polarization-splitting component 202). Accordingly, the image 212 may also include a third polarization image 212c and a fourth polarization image 212d corresponding to these regions of the image sensor. Accordingly, one or more processors (e.g., processor 136) may receive the image 212 generated by the polarization-splitting camera and may use information from the image 212 to generate the individual polarization images 212a-212d.

The presence of the lens stack 204, however, adds to the height of the polarization-splitting camera 200 along an imaging axis of the polarization-splitting camera 200. When incorporated into an electronic device, such as the electronic device 100 of FIGS. 1A-1C, the size of the polarization-splitting camera 200 may provide constraints on where the polarization-splitting camera 200 is positioned within the electronic device and/or constraints on how the polarization-splitting camera 200 may be positioned relative to other components of the electronic device. Accordingly, it may be desirable to provide for low-profile polarization-splitting cameras.

The polarization-splitting cameras described herein are configured to include a metasurface assembly that is configured to receive light from a field of coverage (also referred to herein as the “assembly field of coverage”) and is configured to split this light into individual light beams having different polarization states. The metasurface assembly is further configured to route the light beams of different polarization states to different portions of an image sensor. Accordingly, different portions of the image sensor may collect light having different polarization states, and the polarization-splitting camera may capture an image in which different image pixels correspond to measured light of different polarization states. One or more processors may receive the image generated by the polarization-splitting camera and may process information from the image to reconstruct a plurality of individual polarization images, such as described in more detail herein.

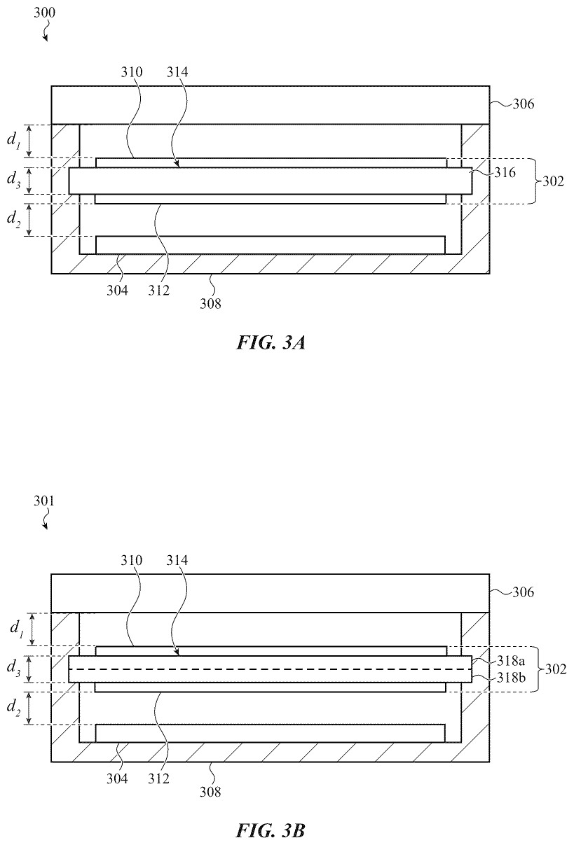

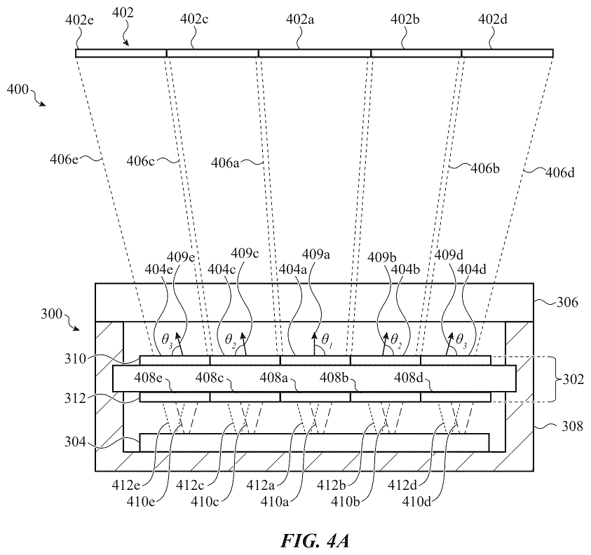

The metasurface assembly of the polarization-splitting cameras described herein include at least a first metasurface layer and a second metasurface layer. For example, FIG. 3A shows a first variation of a polarization-splitting camera 300 as described herein, which includes a metasurface assembly 302, and image sensor 304 that includes an array of sensor pixels, and a cover layer 306. In some variations, the polarization-splitting camera 300 may include a housing 308 that is configured to at least partially enclose the components of the polarization-splitting camera 300. The metasurface assembly 302 includes a first metasurface layer 310 and a second metasurface layer 312, and is configured to i) receive light that passes through the cover layer 306 and ii) direct this light to the image sensor 304. The image sensor 304 may capture an image using light received by the metasurface assembly 302, and this image may be analyzed (e.g., using one or more processors) to generate a plurality of polarization images.

The cover layer 306 may define an exterior surface of the polarization-splitting camera 300, such that light measured by the image sensor 304 may enter the polarization-splitting camera 300 through the cover layer 306. The cover layer 306 may be formed from one or more transparent materials, such as glass, crystal (e.g., sapphire), a transparent polymer (e.g., plastic), or the like. When the polarization-splitting camera 300 is incorporated into an electronic device (e.g., the electronic device 100 of FIGS. 1A-1C), the cover layer 306 may also define an exterior surface of the electronic device. In other variations, the cover layer 306 may not define an exterior surface of the electronic device, and one or more additional layers (e.g., transparent layers formed from the same or different materials as those used to form the cover layer 306) may be positioned between the cover layer 306 and a scene imaged by the polarization-splitting camera 300.

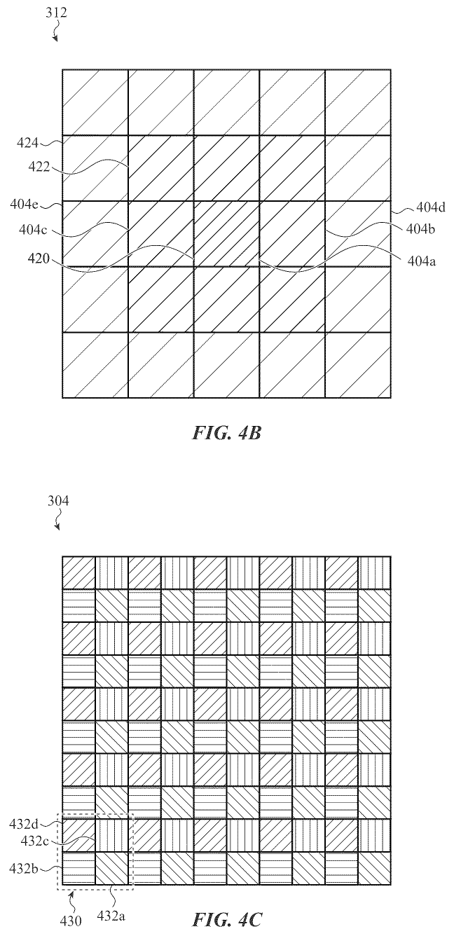

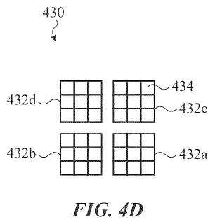

In some variations, such as shown in FIG. 3A, the metasurface assembly 302 is positioned directly behind the cover layer 306, such that the polarization-splitting camera 300 does not include any intervening optical elements (e.g., lenses) that change the direction of light between the cover layer 306 and the metasurface assembly 302. In these variations, light enters the metasurface assembly 302 along the same trajectory at which it enters the polarization-splitting camera 300 through the cover layer 306. Accordingly, the assembly field of coverage of the metasurface assembly 302 may match the field of view of the polarization-splitting camera 300, such as described in more detail with respect to FIG. 4.

Similarly, in some variations the image sensor 304 may be positioned directly behind the metasurface assembly 302, such that the polarization-splitting camera 300 does not include any intervening optical elements (e.g., lenses) that change the direction of light between the metasurface assembly 302 and the image sensor 304. In these variations, light enters the image sensor 404 along the same trajectory at which it exits the metasurface assembly 302. It should be appreciated, however, that the image sensor 304 may be configured to further shape (e.g., using a microlens array or a metasurface layer positioned on an input surface of the image sensor 304) light that is incident on the image sensor 304.

Additionally, it should be appreciated that in some variations the polarization-splitting camera 300 may include one or more filters positioned between components of the polarization-splitting camera 300 (e.g., between the cover layer 306 and the metasurface assembly 302, between the metasurface assembly 302 and the image sensor 304, or between components of the metasurface assembly 302). In these instances, a filter may not alter the direction of light as it passes through the filter, and thus may not be considered an intervening optical element. Instead, a filter may be used to adjust what wavelengths of light are measured by the polarization-splitting camera 300. Specifically, a filter may be configured to filter incoming light received by the polarization-splitting camera and restrict the wavelengths of light that reaches the image sensor 304. Accordingly, a filter may, alone or in combination with other elements that filter light, determine the range of operating wavelengths across which the polarization-splitting camera 300 measures when capturing an image. For example, the polarization-splitting camera 300 may include a filter having a passband that spans a range of wavelengths. In some instances, the passband may have a bandwidth less than 50 nm. In some of these variations, the passband has a bandwidth less than 30 nm. In some instances, the passband may include a range of infrared wavelengths.

In instances where the metasurface assembly 302 is positioned directly behind the cover layer 306 and the image sensor 304 is positioned directly behind the metasurface assembly 302, the polarization-splitting camera 300 may not include any lenses, which may allow for the polarization-splitting camera 300 to achieve a low profile as compared to polarization-splitting cameras that include a lens stack. This may allow for greater flexibility in accommodating the available space constraints when incorporating the polarization-splitting camera 300 into an electronic device.

In some variations, the metasurface assembly 302, the image sensor 304, and the cover layer 306 are all held in a fixed relationship. For example, in the variation shown in FIG. 3A, the housing 308 is configured to i) hold the metasurface assembly 302 at a first distance d₁ from the cover layer 306 and ii) hold the metasurface assembly 302 at a second distance d₂ from the image sensor 304. Accordingly, the metasurface assembly 302 may be separated from the cover layer 306 by a first gap (e.g., an air gap). Similarly, the metasurface assembly 302 may be separated from the image sensor 304 by a second gap (e.g. an air gap).

Within the metasurface assembly, the first metasurface layer 310 and the second metasurface layer 312 may be separated by a third distance d₃. The first metasurface layer 310 and the second metasurface layer 312 may be positioned relative to each other in any suitable manner. Specifically, each of the metasurface layers described herein (e.g., the first and second metasurface layers 310, 312) is formed on a surface of corresponding substrate. For example, a surface of a substrate may be may lithographically patterned to define a series of sub-wavelength structures, also referred to herein as nanopillars, that collectively form the metasurface layer. The relative sizes, shapes, and spacing of these nanopillars may be selected to achieve the optical properties of the metasurface layer, as will be readily understood by someone of ordinary skill in the art.

In some variations, the first metasurface layer 310 and the second metasurface layer 312 may be connected to each other by an intervening set of substrates 314. In some of these variations, such as shown in FIG. 3A, the set of substrates 314 includes a single substrate 316. In these variations, the first and second metasurface layers 310, 312 may formed on opposite surfaces of the substrate 316 (e.g., the first metasurface layer 310 is formed on a first surface of the substrate 316 and the second metasurface layer 312 is formed on a second surface of the substrate 316 opposite the first surface). In these instances, the thickness of the substrate 316 may define the distance da between the first metasurface layer 310 and the second metasurface layer 312.

In other variations, the set of substrates 314 may include a plurality of substrates. For example, FIG. 3B shows another variation of a polarization-splitting camera 301 as described herein. The polarization-splitting camera 301 may be configured and labeled the same as the polarization-splitting camera 300 of FIG. 3A, except that the set of substrates 314 includes a plurality of substrates 318a-318b. In these variations, the first metasurface layer 310 may be formed on a corresponding surface of a first substrate 318a of the plurality of substrates 318a-318b, and the second metasurface layer 312 may be formed on a corresponding surface of a second substrate 318b of the plurality of substrates 318a-318b. The first substrate 318a may be connected to the second substrate 318b (e.g., with the first and second metasurface layers 310, 312 facing in opposite directions) to connect the first metasurface layer 310 to the second metasurface layer 312. In these instances, the distance da between the first metasurface layer 310 and the second metasurface layer 312 may be defined by the combined thicknesses of the first and second substrates 318a, 318b.

In still other variations, the first metasurface layer 310 may not be connected the second metasurface layer 312, such that there is a gap (e.g., an air gap) between the first metasurface layer 310 and the second metasurface layer 312. For example, the first substrate 318a and the second substrate 318b may be positioned such that there is a gap between the substrates, and thus the distance da between the first metasurface layer 310 and the second metasurface layer 312 may be defined at least in part by this gap between the first and second substrates 318a, 318b.

While the first metasurface layer 310 is shown in FIGS. 3A and 3B as being separated from the cover layer 306 by an air gap, in other variations the first metasurface layer 310 (and thereby the metasurface assembly 302) may be connected to the cover layer 306. For example, in instances where the first metasurface layer 310 is formed on a surface of substrate (e.g., the substrate 316 of FIG. 3A or the first substrate 318a of FIG. 3B), that substrate may be positioned in contact with the cover layer 306. In a variation of the polarization-splitting camera 301 shown in FIG. 3B, the first substrate 318a may be connected to the cover layer 306 with the first metasurface layer 310 facing away from the cover layer 306. In these instances, the first metasurface layer 310 may be connected to the cover layer 306 by the first substrate 318a, and the first substrate 318a may hold the first metasurface layer 310 at the first distance d₁ from the cover layer 306. In these instances, the first distance d₁ may correspond to a thickness of the first substrate 318a. In still other variations, the first metasurface layer 310 may be formed on an interior surface of the cover layer 306 or may be otherwise placed in contact with the interior surface of the cover layer 306.

The metasurface assembly 302 may be configured such that different regions of the metasurface assembly 302 (also referred to herein as “assembly regions”) are configured to collect light from different portions of the field of view of the polarization-splitting camera 300. Specifically, the first metasurface layer 310 may be divided into a corresponding plurality of regions (also referred to herein as “routing regions”). Similarly, the second metasurface layer 312 may be divided into a corresponding plurality of regions (also referred to herein as “splitting regions”). Accordingly, the metasurface assembly 302 may be divided into an array of assembly regions, where each assembly region includes a corresponding routing region of the first metasurface layer 310 and a corresponding splitting region of the second metasurface layer 312.

Each assembly region of array is configured to i) collect light from a substantially different corresponding portion of the field of view of the polarization-splitting camera 300, ii) split the collected light into a corresponding plurality of light beams having different polarization states, and iii) direct the corresponding plurality of light beams to a corresponding region of the image sensor 304 (also referred to herein as a “sensing region” of the image sensor 304). Each sensing region of the image sensor 304 may include a plurality of subregions, where each subregion receives light of a different polarization from the metasurface assembly 302. Specifically, the assembly regions of the metasurface assembly are configured to direct each output beam of the corresponding plurality of light beams to a different subregion of the sensing region.

These principles are described herein with respect to FIGS. 4A-4D. For example, FIG. 4A shows a scene 400 in which the polarization-splitting camera 300 of FIG. 3A is used to capture an image of a field of view 402 of the polarization-splitting camera 300. The first metasurface layer 310 is divided into an array of routing regions 404a-404c and the second metasurface layer 312 is divided into an array of splitting regions 408a-408e. While a single row of routing regions 404a-404e is depicted in FIG. 4A, it should be appreciated that the array of routing regions may be configured in a two-dimensional array having rows and columns of routing regions, such as shown in FIG. 4B. Similarly, while a single row of splitting regions 408a-408c is depicted in FIG. 4A, it should be appreciated that the array of splitting regions may be configured in a two-dimensional array having rows and columns of splitting regions.

Accordingly, the metasurface assembly 302 is includes an array of assembly regions, each of which includes a corresponding routing region of the first metasurface layer 310 and a corresponding splitting region of the second metasurface layer 312. Each assembly region of the array is configured to collect light from a different portion of the field of view, which allow the array of assembly regions to collective light from a larger overall field of view (as compared to an individual assembly region). Accordingly, two assembly regions may collect light from a combined portion of the field of view that is larger than the portion of the field of view imaged by an individual assembly region. In some variations, each assembly region of the array is configured to collect light from a substantially different portion of the field of view. As used herein, two portions of a field of view are considered to be “substantially different” if less than 20% of each portion overlaps with the other when imaged by the polarization-splitting camera. In instances where there is some overlap between two portions of the field of view 402, an image captured by the polarization-splitting camera 300 may include image pixels that have duplicative information. The one or more processors may account for this overlap when generating polarization images (e.g., by removing duplicative image pixels).

In some variations, the array of assembly regions may be configured to have even less overlap between different portions of the field of view. For example, the assembly regions of the array of assembly regions may be configured to collect light from different portions of the field of view having less than 5% overlap (e.g., each assembly region captures light from a corresponding portion of the field of view having less than 5% overlap with each corresponding portion of the field of view captured by the other assembly regions). In some of these variations, the assembly regions of the array of assembly regions may be configured to collect light from different portions of the field of view having less than 1% overlap (e.g., each assembly region captures light from a corresponding portion of the field of view having less than 1% overlap with each corresponding portion of the field of view captured by the other assembly regions).

The first metasurface layer 310 may be configured to selectively collect light from a corresponding portion of the field of view 402 and may route light from that portion of the field of view 402 to the second metasurface layer 312. Specifically, each routing region of the first metasurface layer 310 may have a corresponding field of coverage, which corresponds to the spatial extent of the space around the first metasurface layer 310 that is directed to the second metasurface layer 312. In effect, each routing region of the first metasurface layer 310 acts as a corresponding lens having a field of view (e.g., corresponding to the field of coverage) that is imaged onto a corresponding splitting region of the second metasurface layer. The field of coverage may be defined by a chief ray and a set of angle ranges around the chief ray. For example, in some variations, each of the routing regions 404a-404e is configured to have a rectangular field of coverage defined by a chief ray, a first angle range around the chief ray in a first direction, and a second angle range around the chief ray in a second direction perpendicular to the first direction. In some of these variations, such as shown in FIG. 4B, each of the routing regions 404a-404e is configured to have a square field of coverage, in which the first and second angle ranges around the chief ray are the same. Additionally, it should be appreciated that, depending on the design on the metasurface assembly 302, different routing regions within an array of routing regions may have corresponding fields of coverage with different shapes and/or sizes.

The routing regions of the array of routing regions of the first metasurface layer 310 may have different corresponding fields of coverage, which collectively provide a larger overall field of coverage for the array of routing regions. Accordingly, two routing regions with different fields of coverage may collectively form a combined field of coverage that is larger than each individual field of coverage of these routing regions. In some variations, the array of routing regions of the first metasurface layer 310 may have substantially non-overlapping fields of coverage, such that each routing region collects light from a substantially different portion of the field of view 402 of the polarization-splitting camera 300. As used herein, two routing regions of the first metasurface layer 310 are considered to have “non-overlapping fields of coverage” if less than 20% of the field of coverage of each routing region overlaps with each corresponding field of coverage of the other routing regions at a working distance of the first metasurface layer 310 (e.g., the distance from the first metasurface layer 310 at which the routing regions image light onto a plane of the second metasurface layer 312). Conversely, two fields of coverage are considered to substantially overlap if more than 20% of one of the fields of coverage overlaps with the other field of coverage at the working distance of the first metasurface layer 310.

In some variations, the array of routing regions may be configured to have different corresponding fields of coverage with even less overlap. For example, the array of routing regions may be configured to have different corresponding fields of coverage having less than 5% overlap (e.g., each routing region has a corresponding field of coverage having less than 5% overlap with each corresponding field of coverage of the other routing regions at a working distance of the first metasurface layer 310). In some of these variations, the array of routing regions may be configured to have different corresponding fields of coverage having less than 1% overlap (e.g., each routing region has a corresponding field of coverage having less than 1% overlap with each corresponding field of coverage of the other routing regions at a working distance of the first metasurface layer 310).

For example, five assembly regions of the metasurface assembly 302 are depicted in FIG. 4A. Specifically, a first assembly region of the metasurface assembly 302 includes a first routing region 404a of the first metasurface layer 310 and a first splitting region 408a of the second metasurface layer 312, and is configured to collect light from a first portion 402a of the field of view 402. The first routing region 404a has a first field of coverage 406a that corresponds to the first portion 402a of the field of view 402. Accordingly, the first routing region 404a is configured to image the first portion 402a of the field of view (e.g., light collected from the first field of coverage) onto the first splitting region 408a. The first splitting region 408a is configured, in turn, to split the light it receives from the first routing region 404a into a corresponding first plurality of light beams, each of which has a different polarization state. The first plurality of light beams is shown in FIG. 4A as including a light beam 410a having a first polarization state and a light beam 412a having a second polarization state, though it should be appreciated that the first plurality of light beams may include additional light beams (e.g., a third light beam having a third polarization state and a fourth light beam having a fourth polarization state).

The first assembly region of the metasurface assembly 302 is positioned between a second assembly region (including a second routing region 404b of the first metasurface layer 310 and a second splitting region 408b of the second metasurface layer 312) and a third assembly region (including a third routing region 404c of the first metasurface layer 310 and a third splitting region 408c of the second metasurface layer 312). The second assembly region is configured to collect light from a corresponding second portion 402b of the field of view 402 and the third assembly region is configured to collect light from a corresponding third portion 402c of the field of view 402. Specifically, the second routing region 404b has a second field of coverage 406b that corresponds to the second portion 402b of the field of view 402, and is configured to image the second portion 402b of the field of view 402 onto the second splitting region 408b. The second splitting region 408b is configured to split light received from the second routing region 404b into a corresponding second plurality of light beams, each of which has a different polarization state (e.g., a light beam 410b having the first polarization, a light beam 412b having the second polarization, and so on). Similarly, the third routing region 404c has a third field of coverage 406c that corresponds to the third portion 402c of the field of view 402, and is configured to image the third portion 402c of the field of view onto the third splitting region 408c. The third splitting region 408c is configured to split light received from the third routing region 404c into a corresponding third plurality of light beams, each of which has a different polarization state (e.g., a light beam 410c having the first polarization, a light beam 412c having the second polarization, and so on).

As shown in FIG. 4A, the metasurface assembly 302 includes a fourth assembly region (including a fourth routing region 404d of the first metasurface layer 310 and a fourth splitting region 408d of the second metasurface layer 312) that is configured to split light received from a fourth portion 402d of the field of view 402 (e.g., via a fourth field of coverage 406d corresponding to the fourth routing region 404d) into a fourth plurality of light beams (e.g., a light beam 410d having the first polarization, a light beam 412d having the second polarization, and so on). Similarly, the metasurface assembly 302 includes a fifth assembly region (including a fifth routing region 404c of the first metasurface layer 310 and a fifth splitting region 408e of the second metasurface layer 312) that is configured to split light received from a fifth portion 402c of the field of view 402 (e.g., via a fifth field of coverage 406e corresponding to the fifth routing region 404c) into a fifth plurality of light beams (e.g., a light beam 410e having the first polarization, a light beam 412e having the second polarization, and so on).

The first metasurface layer 310 is configured in FIG. 4A such that the fields of coverage of the array of routing regions 404a-404c do not substantially overlap. In other words, the field of coverage for each routing region does substantially overlap with the fields of coverage of any of the remaining routing regions within the array. Overall, the fields of coverage of the routing regions 404a-404e may collectively define the assembly field of coverage for the metasurface assembly 302. For each routing region of the first metasurface assembly, the angle and direction of the chief ray of the field of coverage may control the location of the corresponding portion of the field of view 402 that is imaged by the routing region. Similarly, the angle ranges around the chief ray may control the size of the corresponding portion of the field of view 402 that is imaged by the routing region. As shown in FIG. 4A, the fields of coverage 406a-406e are associated with corresponding chief rays 409a-409c.

In some variations, the first metasurface layer 310 may include an array of routing regions in which immediately adjacent routing regions are used to image immediately adjacent portions of the field of view 402 onto the second metasurface layer 312. For example, FIG. 4B shows a top view of a variation of the first metasurface layer 312, which includes a first group 420 of routing regions that includes the first routing region 404a, a second group 422 of routing regions that surrounds the first group 420 (and that includes the second and third routing regions 404b, 404c), and a third group 424 of routing regions that surrounds the second group 422 (and that includes the fourth and fifth routing regions 404d, 404c). Accordingly, the first group 420 may be configured to collect light from the first portion 402a of the field of view. For example, the first field of coverage 406a of the first routing region 404a may have a chief ray 409a with a first angle θ₁ relative to the first metasurface layer 310 (which as shown in FIG. 4A is normal to the first metasurface layer 310) and the first portion 402a may be positioned at the center of the field of view 402.

The second group 422 may collectively be configured to collect light from a second area of the field of view that immediately surrounds the first portion of the field of view 402. For example, the second routing region 404b is immediately adjacent to the first routing region 404a on a first side of the first routing region 404a. The second field of coverage 406b of the second routing region 404b may have a chief ray 409b, where the chief ray 409b has a second angle θ₂ relative to the first metasurface layer 310 that is less than the first angle θ₁ and is oriented such that the chief ray 409b is angled away from the chief ray 409a. The difference between the first angle θ₁ and the second angle θ₂ may be selected such that the second portion 402b of the field of view 402 that is imaged by the second routing region 404b is immediately adjacent to the first portion 402a of the field of view 402 on a first side of the first portion 402a. Similarly, the third routing region 404c is immediately adjacent to the first routing region 404a on a second side of the first routing region 404a opposite the first side. The third field of coverage 406c of the third routing region 404c may have a chief ray 409c that also has the second angle θ₂, but is oriented in an opposite direction relative to the chief ray 409b of the second routing region 404b. Accordingly, the third portion 402c of the field of view 402 imaged by the third routing region 404c may be immediately adjacent to the first portion 402a of the field of view 402 on an opposite side of the first portion 402a.

Similarly, the third group 424 may be collectively configured to collect light from a second area of the field of view that immediately surrounds the first area of the field of view. For example, the fourth field of coverage 406d may have a chief ray 409d that is oriented at a third angle θ₃ and directed such that the fourth routing region 404d (which is immediately adjacent to the second routing region 404b) captures light from a fourth portion 402d of the field of view 402 that is immediately adjacent to the second portion 402b of the field of view 402. Similarly, the fifth field of coverage 406e may have a chief ray 409e that is oriented at the third angle θ₃ and directed such that the fifth routing region 404e (which is immediately adjacent to the third routing region 404c) captures light from a fifth portion 402e of the field of view 402 that is immediately adjacent to the third portion 402c of the field of view 402.

Overall, the array of routing regions of the first metasurface layer 310 may allow for a larger overall field of view 402 of the polarization-splitting camera 300 without requiring each individual routing region to accommodate the entire filed of view 402. For example, each row of routing regions (e.g., the row of routing regions 404a-404e shown in FIG. 4A) may have corresponding fields of coverage (e.g., fields of coverage 406a-406e) with a first common angle range around their chief rays in a row direction (e.g. the direction along which the row of routing regions 404a-404e is positioned). In one non-limiting example, the first common angle range is +10 degrees, such that the first field of coverage 406a has an angle range in the first direction that is ±10 degrees around the chief ray 409a, the second field of coverage 406b has an angle range in the first direction that is +10 degrees around the chief ray 409b, and so on. Collectively these fields of coverage (including the fields of coverage 406a-406e) may provide a field of view 402 of the polarization camera that spans ±50 degrees along the row direction. Similarly, each column of routing regions may have corresponding fields of coverage with a second common angle around the chief rays in a column direction (e.g. the direction along which the column of routing regions is positioned), which may collectively define the angle span of the field of view 402 along the column direction).

While the first metasurface layer 310 is shown in FIG. 4B as having a single array of routing regions, it should be appreciated that in other variations the first metasurface layer 310 may include multiple arrays of routing regions. In these variations, different portions of the first metasurface layer 310 may be divided into a corresponding array of routing regions. For example, the array of routing regions shown in FIG. 4B may be replicated such that the metasurface layer 310 includes two or more identical arrays of routing regions. In these instances, each array of routing regions may have effectively the same field of coverage. Accordingly, within a given array of routing regions, the routing regions may have substantially non-overlapping fields of coverage, but there may be overlapping fields of coverage between certain routing regions of different arrays.

FIG. 4C shows a top view of the image sensor 304, which may be divided into an array of sensing regions 430. Each sensing region 430 is associated with a corresponding assembly region of the metasurface assembly 302, such that each sensing region 430 receives the plurality of light beams generated by a corresponding splitting region of the second metasurface layer 312. While only a single sensing region 430 is labeled in FIG. 4C for simplicity of illustration, it should be appreciated that additional similarly configured elements in FIG. 4C represent other sensing regions of the image sensor 304. Each sensing region 430 includes a plurality of subregions 432a-432d, each of which is positioned to receive a different light beam from a corresponding splitting region of the second metasurface layer 312.

For example, in the variation shown in FIG. 4C, each sensing region 430 includes a first subregion 432a, a second subregion 432b, a third subregion 432c, and a fourth subregion 432d. In these variations, each splitting region of the second metasurface layer 312 is configured to split incoming light into four light beams having different polarization states. The splitting region, is further configured to direct a first light beam (e.g., having a first polarization state) to the first subregion 432a, a second light beam (e.g., having a second polarization state) to the second subregion 432b, a third light beam (e.g., having a third polarization state) to the third subregion 432c, and a fourth light beam (e.g., having a fourth polarization state) to the fourth subregion 432d. Overall, each splitting region may receive an image of a corresponding portion of the field of view from a corresponding routing region of the first metasurface layer 310, and may direct the plurality of light beams such that each of the plurality of subregions 432a-432d receives a different copy of this image with a different polarization state.

Collectively, the first subregions 432a of the array of sensing regions 430 may include light captured from the field of view 402 having the first polarization state. For example, the first light beams (e.g., beams 410a-410d) generated by the splitting regions of the second metasurface layer 312 may be polarized at a 0 degree polarization angle. When processing an image captured by the polarization-splitting camera 300, one or more processors may use image pixels corresponding to the first subregions 432a to reconstruct the field of view 402 and generate a first polarization image corresponding to the first polarization state. The second subregions 432b of the array of sensing regions 430 may include light captured from the field of view 402 having the second polarization state. For example, the second light beams (e.g., beams 412a-412d) generated by the splitting regions of the second metasurface layer 312 may be polarized at a 45 degree polarization angle. When processing an image captured by the polarization-splitting camera 300, one or more processors may use image pixels corresponding to the second subregions 432b to reconstruct the field of view 402 and generate a second polarization image corresponding to the second polarization state. The third subregions 432c may collect light from light beams having a third polarization state (e.g., light beams polarized at a 90 degree polarization angle), and image pixels corresponding to the third subregions 432c may be used to generate a third polarization image corresponding to the third polarization state. Similarly, the fourth subregions 432d may collect light from light beams having a fourth polarization state (e.g., light beams polarized at a 135 degree polarization angle), and image pixels corresponding to the fourth subregions 432d may be used to generate a fourth polarization image corresponding to the fourth polarization state. Overall, in these variations a single image captured by the polarization-splitting camera 300 may be used to generate four different polarization images.

While sensing regions 430 are shown in FIG. 4C as having four different subregions, it should be appreciated that each sensing region 430 may have a plurality of subregions 432a-432d with any number of subregions. For example, each of plurality of subregions 432a-432d may include two subregions, three subregions, or five or more subregions, depending on the number of light beams generated by a corresponding splitting region. It should be appreciated that the splitting regions may generate a plurality of light beams having any combination of polarization states (e.g., one or more linear polarization states, one or more circular polarization states, and/or one or more elliptical polarization states), and accordingly an image captured by the polarization-splitting camera 300 may be used to generate a plurality of polarization images corresponding to these polarization states.

In some variations, each of the subregions 432a-432d of a sensing region 430 includes a single corresponding sensor pixel of the image sensor. In other variation each of the subregions 432a-432d of a sensing region 430 includes a plurality of sensor pixels of the image sensor. For example, FIG. 4D shows a top view of a sensing region 430 of the image sensor 304 of FIG. 4C. As shown there, each subregion of the plurality of subregions 432a-432d (which are depicted in FIG. 4D as being spaced apart for the purpose of illustration) includes an N×M array of sensor pixels 434 of the image sensor 304. While only a single sensor pixel 434 is labeled in FIG. 4D for simplicity of illustration, it should be appreciated that additional similarly configured elements in FIG. 4D represent other sensor pixels 434 of the image sensor 304. The N×M arrays of sensor pixels 434 corresponding to the plurality of subregions 432a-432d may configured a one-dimensional array (e.g., having a single row or column) or a two-dimensional array (e.g., having multiple rows and columns) as may be desired.

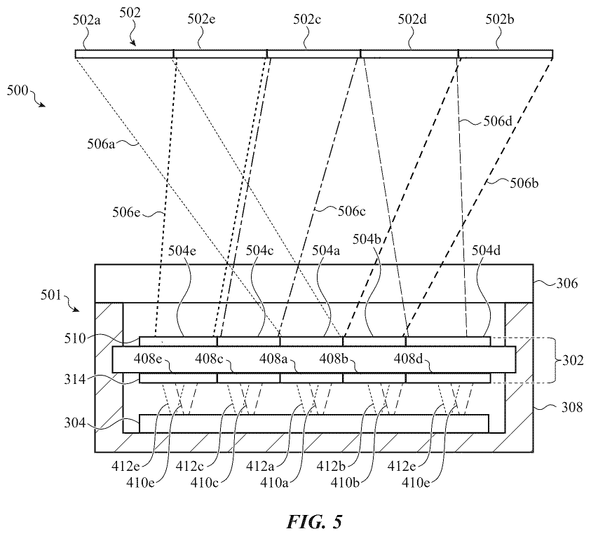

In some variations, an array of assembly regions of a metasurface assembly may be configured such that one or more pairs of immediately adjacent assembly regions are configured to collect lights from non-adjacent portions of the polarization-splitting camera's field of view. For example, FIG. 5 shows a scene 500 in which a polarization-splitting camera 501 is positioned to capture an image of a field of view 502 of the polarization-splitting camera 501. The polarization-splitting camera 501 may be configured and labeled the same as the polarization-splitting camera 300 described herein with respect to FIGS. 3A-4D, except that the first metasurface layer 310 of the metasurface assembly 302 has been replaced by first metasurface layer 510. Specifically, the first metasurface layer 510 includes an array of routing regions having at least a row of routing regions 504a-504e. The row of routing regions 504a-504e have corresponding fields of coverage 506a-506e and are configured to capture light from substantially different portions 502a-502e of the field of view 502, such as described in more detail herein.

As shown in FIG. 5, a first routing region 504a may positioned immediately adjacent to a second routing region 504b, but these routing regions are used to capture light from non-adjacent portions of the field of view. Specifically, the first routing region 504a may be configured to capture light from a first portion 502a of the field of view 502 and the second routing region 504b may be configured to capture light from a second portion 502b of the field of view 502. These portions 502a-502b may be separated by other portions (e.g. portions 502c-502d) that are imaged by other routing regions of the array.

It should be appreciated that the array of routing regions may have any suitable correspondence between routing regions and imaged portions of the field of view 502. For example, two non-adjacent routing regions (e.g., a third second routing region 504c and a fourth routing region 504d, which are separated by the first and second routing regions 504a, 504c) may collected light from immediately adjacent portions of the field of view 502 (e.g., a third portion 502c and a fourth portion 502d). Additionally or alternatively, two immediately adjacent routing regions (e.g., the third routing region 504c and a fifth routing region 504e) may collect light from immediately adjacent portions of the filed of view 502 (e.g., the third portion 502c and a fifth portion 502e).

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A polarization-splitting camera, comprising:
an image sensor comprising an array of sensor pixels divided into a plurality of sensing regions;
a first metasurface layer comprising an array of routing regions having corresponding fields of coverage; and
a second metasurface layer positioned between the first metasurface layer and the image sensor, the second metasurface layer comprising an array of splitting regions, wherein:
each routing region of the array of routing regions has a different corresponding field of coverage;
each routing region of the array of routing regions is configured to direct light received from the corresponding field of coverage to a corresponding splitting region of the array of splitting regions;
the corresponding splitting region is configured to split the received light into a corresponding plurality of light beams, each output beam of the corresponding plurality of light beams having a different polarization state;
the corresponding splitting region is configured to direct the corresponding plurality of light beams to a corresponding sensing region of the plurality of sensing regions; and
the corresponding fields of coverage of the array of routing regions do not substantially overlap.

2. The polarization-splitting camera of claim 1, wherein:
each sensing region of the plurality of sensing regions comprises a corresponding plurality of subregions; and
the corresponding splitting region is configured to direct each output beam of the corresponding plurality of light beams to a different subregion of the corresponding plurality of subregions of the corresponding sensing region.

3. The polarization-splitting camera of claim 2, wherein:
each subregion of each sensing region of the plurality of sensing regions comprises a plurality of sensor pixels.

4. The polarization-splitting camera of claim 1, wherein:
the fields of coverage of the array of routing regions have a common size.

5. The polarization-splitting camera of claim 1, comprising a cover layer.

6. The polarization-splitting camera of claim 1, comprising a set of substrates connecting the first metasurface layer to the second metasurface layer.

7. An electronic device, comprising:
a polarization-splitting camera configured to capture an image of a field of view of a scene, the polarization-splitting camera comprising:
a cover layer;
a metasurface assembly positioned directly behind the cover layer, the metasurface assembly comprising a first metasurface layer and a second metasurface layer; and
an image sensor positioned behind the metasurface assembly, wherein:
the metasurface assembly comprises an array of assembly regions, wherein each assembly region of the metasurface assembly is configured to:
collect light from a substantially different corresponding portion of the field of view;
split the collected light into a plurality of light beams having different polarization states; and
direct each of the plurality of light beams to a different corresponding portion of the image sensor.

8. The electronic device of claim 7, wherein the cover layer defines an exterior surface of the electronic device.

9. The electronic device of claim 7, wherein:
each assembly region of the metasurface assembly comprises a corresponding region of the first metasurface layer and a corresponding region of the second metasurface layer;
the corresponding region of the first metasurface layer is configured to route light received from the corresponding portion of the field of view to the corresponding region of the second metasurface layer.

10. The electronic device of claim 7, wherein the metasurface assembly comprises a set of substrates connecting the first metasurface layer to the second metasurface layer.

11. The electronic device of claim 10, wherein the set of substrates comprises a plurality of substrates.

12. The electronic device of claim 7, wherein the metasurface assembly is separated from the cover layer by a gap.

13. The electronic device of claim 7, wherein the metasurface assembly is separated from the image sensor by a gap.

14. The electronic device of claim 7, wherein immediately adjacent assembly regions are configured to collect light from immediately adjacent portions of the field of view.

15. The electronic device of claim 7, comprising:
one or more processors configured to generate a plurality of polarization images from the captured image.

16. A polarization-splitting camera comprising:
a cover layer;
an image sensor; and
a metasurface assembly comprising:
a first metasurface layer defining an array of routing regions having substantially non-overlapping fields of coverage;
a second metasurface layer; and
a set of substrates connecting the first metasurface layer to the second metasurface layer; wherein:
each routing region of the array of routing regions is configured to direct light received through the cover layer to a corresponding region of the second metasurface layer; and
the corresponding region of the second metasurface layer is configured to split the received light into a corresponding plurality of light beams, each output beam of the corresponding plurality of light beams having a different polarization state.

17. The polarization-splitting camera of claim 16, wherein the corresponding plurality of light beams comprises:
a first light beam having a first polarization state;
a second light beam having a second polarization state;
a third light beam having a third polarization state; and
a fourth light beam having a fourth polarization state.

18. The polarization-splitting camera of claim 17, wherein:
the first light beam is polarized at a 0 degree polarization angle;
the second light beam is polarized at a 45 degree polarization angle;
the third light beam is polarized at a 90 degree polarization angle; and
the fourth light beam is polarized at a 135 degree polarization angle.

19. The polarization-splitting camera of claim 16, wherein the set of substrates comprises a plurality of substrates.

20. The polarization-splitting camera of claim 16, wherein the metasurface assembly is separated from the image sensor by a gap.
